(19) United States
(12) Patent Application Publication
(10) Pub. No.: US 2020/0305170 A1
(43) Pub. Date: Sep. 24, 2020

(54) Efficient Link Adaptation in Unlicensed Spectrum

(71) Applicant: Telefonaktiebolaget LM Ericsson (publ), Stockholm (SE)

(72) Inventors: Thomas Nilsson, Malmö (SE); Peter Alriksson, Hörby (SE); Fredrik Nordström, Lund (SE)

(21) Appl. No.: 16/649,471

(22) PCT Filed: Sep. 20, 2017
(86) PCT No.: PCT/EP2017/073802

§ 371 Date: Mar. 20, 2020

(51) Int. Cl. H04W 72/08; H04W 16/14; H04W 24/08; H04L 1/00; H04B 7/0456; H04W 74/08

(52) U.S. Cl. CPC H04W 72/082; H04W 16/14; H04W 24/08; H04W 84/12; H04B 7/0486; H04W 74/0808; H04L 1/0003

(57) ABSTRACT

A base station (11) of a wireless cellular communication network operating in unlicensed spectrum adjusts (118) the robustness of a downlink transmission in response to the power level of any interference encountered in the channel and the source of the interference. The base station (11) estimates (110) whether the source of interference encountered is a eLAA or WLAN network (110). An offset to a transmission format—a measure of transmission robustness to noise and interference—is calculated (112) in response to the interference power level and the source of the interference. An initial transmission format is adjusted (118) by the offset, and data are transmitted (120) to a UE using the adjusted transmission format. In other embodiments, the base station (11) may compare its interference to that detected by the target UE, to ascertain whether the two likely have the same source. Similarly, in some embodiments the base station may perform a spatial analysis such as angle of arrival to ascertain whether the source of interference is physically close to the target UE. In these embodiments, the base station may further adjust the transmission format in response to information gleaned about the source of interference.

### TECHNICAL FIELD

The present disclosure relates generally to wireless cellular communication systems, and in particular to efficient link adaptation when a base station operates in unlicensed spectrum.

### BACKGROUND

Wireless cellular communication networks are broadly deployed across the world. Network operators license defined portions (La, frequency bands) of the electromagnetic spectrum from government agencies, and operate wireless cellular communication networks within those portions. While there is always interference, network operators generally do not have to worry about the deployment of other wireless network operators (cellular or otherwise) in the same frequency spectrum in the same geographic locations. Accordingly, the technical protocols defining network operation and functionality—for example, those developed and promulgated by the Third Generation Partnership Project (3GPP)—lack robust collision avoidance mechanisms, which are common in other networking technologies (e.g., Ethernet, wireless local area networks (WLAN), and the like).

The 3GPP work on enhanced Licensed-Assisted Access (d) intends to allow Long Term Evolution (LTE) equipment, including a base station or enhanced NodeB (eNB), to also operate in unlicensed radio spectrum. Supported bands for LTE operation in the unlicensed spectrum include 5 GHz, 3.5 GHz, etc. The unlicensed spectrum may be used as a complement to the licensed spectrum, or may be completely standalone operation. MulteFire is an example of a LTE-based standalone radio access technology that operates solely in unlicensed spectrum. Licensed-assisted and standalone operation in unlicensed spectrum will also be supported by 5G New Radio (NR). As used herein, the term enhanced Licensed-Assisted Access (eLAA) refers to any LTE or NR based technology operating in unlicensed spectrum. The term includes protocols such as MulteFire, LTE-Unlicensed (LTE-U), NR-Unlicensed (NR-U), and the like. The term eLAA is a functional description, it is non-limiting, and should be construed broadly.

Not only do wireless cellular communication network operators have to contend with the possibility of other operators' base stations operating in the same geographic area and frequency band, but additionally many non-cellular wireless networks and other sources of interference also present potential conflicts. One particular example is WLANs based on the IEEE 802.11x family of standards, known generally as Wi-Fi. Wi-Fi networks are widely deployed in both residential and business settings, and operate in unlicensed spectrum. Because Wi-Fi was designed for use in contested spectrum, it includes collision avoidance. In particular, Wi-Fi utilizes a Listen-Before-Talk (LBT) method, also known as Clear Channel Assessment (CCA), whereby an Access Point (AP) having data to transmit will first access the channel to ascertain whether another transmission is ongoing—i.e., it looks for interference. If a sufficiently strong signal is encountered, the transmission is deferred and a retry timer started. Upon expiration of the timer, the AP will try again. The Wi-Fi CCA level for backing off of a transmission is −62 dBm; interference encountered below that power level is treated as noise, and the transmission proceeds.

A LBT approach has been discussed for eLAA, preliminarily using the CCA power level of −72 dBm—a lower power than the Wi-Fi CCA level—giving rise to an imbalance in interference avoidance. That is, an eLAA eNB that “hears” an ongoing Wi-Fi transmission will “back off” and defer access to the channel. However, the reverse may not be true. If a Wi-Fi AP encounters an ongoing downlink eLAA transmission, it may well ignore it and proceed to transmit, treating the eLAA transmission as noise. The eLAA downlink (DL) transmission will, in this case, experience very strong interference from the Wi-Fi transmission. Since such interference was not anticipated or considered by the eNB, its link adaptation will likely not be able to account for it, resulting in errors or possibly a failure of the entire transmission. This zone of anticipated high interference extends up to the Wi-Fi CAA level of −62 dBm, above which the Wi-Fi AP LBT mechanism will defer its transmissions.

The coexistence with Wi-Fi and other eLAA cells on the unlicensed band poses additional challenges for efficient link adaptation in eLAA. The non-deterministic access of the channel introduces an additional uncertainty when it comes to feedback delays and interference. The unlicensed channel might be occupied for longer periods by other Wi-Fi and/or eLAA devices making reported Channel State Information (CSI) obsolete. The interference on the unlicensed bands adds an additional degree of uncertainty since the interference from Wi-Fi is typically of a bursty nature.

Furthermore, operation on the 5 GHz band, compared to the 2.4 GHz Industrial, Scientific, and Medical (ISM) band, results in a higher Doppler spread for the same speed. The coherence time is proportional to the carrier frequency and a small coherence time requires short feedback delays for efficient link adaptation.

### SUMMARY

According to embodiments of the present invention described and claimed herein, an eLAA eNB monitors ambient interference prior to transmission, and adjusts the robustness of a DL transmission in response to the power level of interference detected in the channel and the source of the interference. The eNB measures the interference power level, and estimates the source of the interference, e.g., eLAA or WLAN. An offset to a transmission format—a measure of transmission robustness to noise and interference—is calculated based on the interference power level and the source of interference. The offset may be a continuous function, for each source of interference, to the interference power level. Alternatively, a window may be defined around a characteristic interference power level unique to each source of interference, and the detected interference classified into categories around the window (e.g., above, within, and below the window). The transmission format offset may then be defined differently for each category of interference. In some embodiments, the eNB may compare its interference to that detected by the target UE, to ascertain whether the two likely have the same source. Similarly, in some embodiments the eNB may perform a spatial analysis such as angle of arrival to ascertain whether the source of interference is physically close to the target UE. In these embodiments, the eNB may further adjust the transmission format in response to information gleaned about the source of interference. If sufficiently strong interference is encountered in the channel, the DL transmission is deferred (e.g., LBT is implemented by the eNB).

One embodiment relates to a method of operating a base station of a wireless cellular communication system in unlicensed spectrum. Data is prepared for a transmission over a downlink channel to a UE. An initial transmission format for the downlink transmission is determined in response to channel state information about the channel. The downlink channel is monitored for interference. A power level of any detected interference is measured. The source of interference is estimated as being a wireless cellular communication network transmission or a wireless local area network transmission. A transmission format offset is calculated in response to the interference power level and the source of interference. The initial transmission format is adjusted by the offset, and the data are transmitted over the downlink channel using the adjusted transmission format.

Another embodiment relates to a base station of a wireless cellular communication system operative to operate in unlicensed spectrum. The base station includes one or more antennas and a transceiver operatively connected to the antenna. The base station also includes processing circuitry operatively connected to the transceiver and operative to: prepare data for a transmission over a downlink channel to a UE; determine an initial transmission format for the downlink transmission in response to channel state information about the channel; monitor the downlink channel for interference; and measure a power level of any detected interference. The processing circuitry is further operative to estimate the source of interference as being a wireless cellular communication network transmission or a wireless local area network transmission. The processing circuitry is also operative to calculate a transmission format offset in response to the interference power level and the source of interference; adjust the initial transmission format by the offset; and transmit the data over the downlink channel using the adjusted transmission format.

### BRIEF DESCRIPTION OF THE DRAWINGS

FIG. 1 is a diagram of two wireless cellular communication system base stations operating in unlicensed spectrum.

FIG. 2 is a representative graph of the absolute value of transmission format offset vs. interference power level for LAA or eLAA interference.

FIG. 3 is a diagram of a wireless cellular communication system base station operating in unlicensed spectrum in which a wireless local area network is also operating.

FIG. 4 is a representative graph of the absolute value of transmission format offset vs. interference power level for WLAN interference.

FIG. 5 is a representative graph of interference power levels over a measurement interval.

FIG. 6 is a graph depicting categorization of interference by power level.

FIG. 7 is a flow diagram of a method of operating a base station of a wireless cellular communication system in unlicensed spectrum.

FIG. 8 is a block diagram of a base station of a wireless cellular communication system.

FIG. 9 is a diagram of physical units in processing circuitry in the base station of FIG. 8.

FIG. 10 is a diagram of software modules in memory in the base station of FIG. 8.

### DETAILED DESCRIPTION

In licensed spectrum, precise (relative) timing of control signals is possible, because the wireless cellular communication network has exclusive access to the air interface. However, in unlicensed spectrum, regulatory requirements may not permit transmissions without prior channel sensing, transmission power limitations, and/or imposed maximum channel occupancy time. Since the unlicensed spectrum must be shared with other devices of similar or dissimilar wireless technologies, a so-called Listen-Before-Talk (LBT) access method is required. LBT involves sensing the transmission medium, or channel, for a pre-defined minimum amount of time and “backing off,” or deferring access to the channel, if the channel is busy. Therefore, the transmission occasions of reference signals used to discover and measure cells cannot be pre-determined or fixed.

User Equipments (UEs) utilize known reference signals to characterize the channel properties of a communication link, known as Channel State Information (CSI). This information describes how a signal propagates from the transmitter to the receiver and represents the combined effect of, for example, scattering, fading, and power decay with distance. It also includes interference information. The CSI makes it possible to adapt transmissions to current channel conditions—known as link adaptation—which is crucial for achieving reliable communication with high data rates in multi-antenna systems. UEs feeding back CSI to a serving eNB, in order for the eNB to optimally utilize sparse radio spectrum for future DL transmissions, has long been a feature of 3GPP protocols. This enables the eNB to select the optimal Modulation and Coding Scheme (MCS), antenna rank, and beamforming precoding matrix for a packet such that the transmitted packet is correctly received at the receiver (or with a predetermined maximum error rate) after passing through the channel, while still utilizing sparse radio resources efficiently.

The eNB receives CSI reports from UEs containing recommended information about, e.g., MCS, rank, and precoders. The recommended MCS in LTE corresponds to the Channel Quality Indicator (CQI). The recommended MCS is used as baseline for selecting a transmission format. As used herein, the term “transmission format (TF)” refers to how robust or sensitive the modulation and coding are to channel noise and interference. A large TF is very sensitive to noise and requires a higher Signal to Interference and Noise Ratio (SINR) for successful reception, but carries a large amount of data. A lower TF transmits less data, but is more robust and can successfully transmit across a low SINR channel. The TF can for example be a numerical value ranging from 0 to 1, or it can be mapped to the transport block size (See Table 7.1.7.2.1-1 in the 3GPP Technical Specification 36.213, “Evolved Universal Terrestrial Radio Access (E-UTRA); Physical layer procedures,” Rel-8, the disclosure of which is incorporated herein by reference in its entirety). The baseline TF, derived from CSI, is denoted as TF_{base}.

As in LTE, in eLAA uplink (UL) transmissions are scheduled by the base station, or enhanced Node-B (eNB). UEs are not allowed to transmit data without being granted resources by the eNB. The eNB allows uplink (UL) access at specific times by transmitting UL grants to scheduled UEs in the downlink (DL). A UE having new data to send first notifies the eNB by sending a scheduling request (SR) using the Physical UL Control Channel (PUCCH) and indicating that it requires the allocation of UL resources. The UE is required to perform a clear channel assessment (CCA) prior to the UL transmission.

UEs commonly experience highly varying channel conditions. Since CSI feed-back typically requires processing at the UE, transmission from the UE to the eNB, and then further processing at the eNB, a delay is introduced between the instant of CSI measurement and the instant when the data transmission based on the reported CSI information actually takes place at the eNB. During that time, channel conditions may have changed substantially thereby rendering the CSI obsolete, in turn resulting in the eNB using a suboptimal MCS for its transmissions.

To account for changes in channel conditions, the eNB may adjust the TF_{base} to better fit the DL scheduled subframe. The adjustment may take the form of an offset, denoted TF_{offset}, or just “offset.” A positive offset means that a more sensitive TF (more payload bits and/or higher modulation order) will be used, while a negative offset means that a more robust TF (fewer payload bits and/or lower modulation order) will be used. Furthermore, there may be systematic errors in the reported CSI from UEs that the eNB may correct. The eNB can also incorporate other information regarding the channel and interference properties into the offset. The final TF that will be used in the DL transmission to the UE is a function of TF_{base} and TF_{offset}, for example TF_{final}=TF_{base} TF_{offset}, where TF_{offset} may be positive or negative.

The focus of this disclosure is link adaptation in unlicensed spectrum, where an eNB is subject to interference, of various power levels and from different sources. Because the goal is usually to make DL communications more robust in the face of detected channel interference, the offset TF_{offset} will most often be a negative value. Accordingly, discussion herein of the size or relative value of a transmission format offset is made with reference to the absolute value of the offset—in most cases, the actual offset value TF_{offset} will be negative. This will be clear to those of skill in the art, given the context of the detected interference levels and the estimation of the interference source.

Usually eNB strive to achieve a specific average BLock Error Rate (BLER) on the DL transmissions. One approach is to adjust the TF_{offset} partially in response to Hybrid Automatic Repeat Request (HARQ) positive/negative acknowledgements (ACK/NACKs), where an ACK results in a positive offset and a NACK results in a negative offset. The step sizes for changes to the offset may be different for received ACK and NACK, with the goal to achieve the target BLER with fast adaptation to newly changed channel conditions, but without changing the MCS often in a short time. This is known as Outer Loop Link Adaptation.

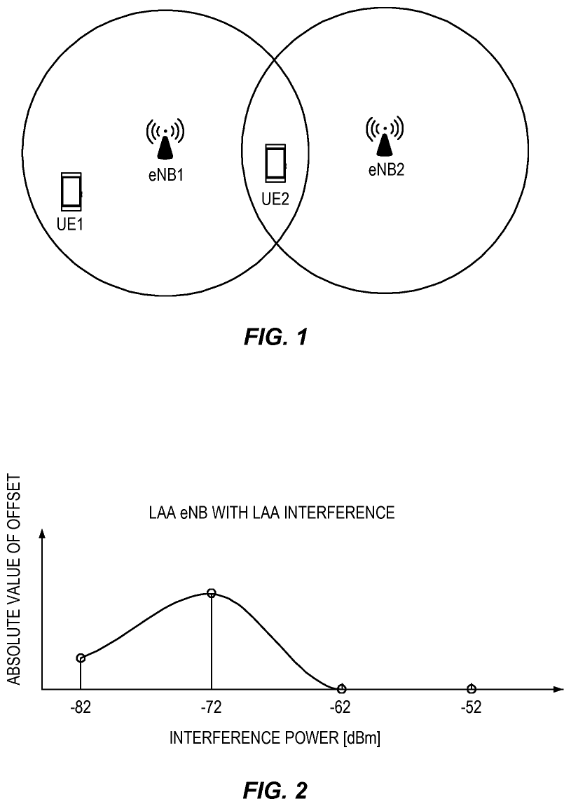

FIG. 1 depicts two wireless cellular communication network base station nodes (e.g., eNB), and their respective cells, or coverage areas. The eNBs operate in unlicensed spectrum, and are not necessarily planned and operated to minimize interference, as are 3GPP networks in licensed spectrum. UE₁ is located within the eNB₁ cell, and receives little or no interference from eNB₂. However, UE₂ is located in an overlapping zone, and receives DL transmissions from both eNB₁ and eNB₂. The eNB₂ transmissions (whether eNB₂ is within the same wireless network as eNB₁ or not) are interference at UE₂ to DL transmissions from eNB₁ to UE₂.

Prior to initiating a DL transmission to UE₂, eNB₁ monitors the channel for a duration, to discover any interference. In some embodiments, eNB₁ monitors the channel periodically, and maintains statistics of detected interference. If interference from eNB₂ is discovered, eNB₁ will adjust an initial transmission format determined in response to CSI from UE₂, to ensure the DL transmission to UE₂ is sufficiently robust to meet a target BLER. In one embodiment, the relationship between the detected interference power and the absolute value of the offset is a continuous function.

FIG. 2 depicts one relationship between the detected interference power level and the offset for eLAA interference. The absolute value of the offset is a continuous function of the interference power level, where the source of interference is identified as eLAA. Assume the LBT threshold for eLAA operation is −72 dBm. This means that eNB₂ will not defer transmissions in the face of eNB₁ DL transmissions at or below this level, causing interference at UE₂. To make DL transmissions to UE₂ sufficiently robust, eNB₁ applies a negative offset to the calculated transmission format—as FIG. 2 depicts, the maximum value of this negative offset occurs at detected interference power levels at and near the eLAA LBT threshold of −72 dBm. This is referred to herein as a “characteristic interference power level” for eLAA transmitters, because it defines a characteristic of eLAA transmissions—they will be deferred in the face of interference above that level.

To account for channel fading and the like, eNB₁ adds a 10 dBm margin, and applies an offset up to detected interference power levels of −62 dBm. Above this level, eNB₁ expects that eNB₂ will defer DL transmissions, and no offset is required. As FIG. 2 also depicts, smaller interference power levels (e.g., below −72 dBm) will permit a lower absolute value of offset—allowing greater data transmission efficiency while maintaining a sufficiently robust transmission format to achieve the desired BLER.

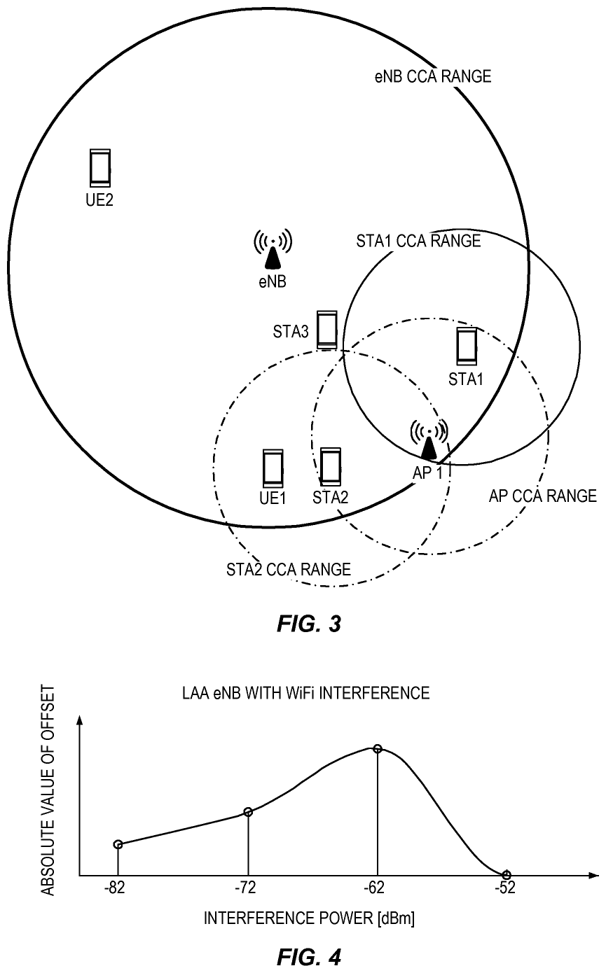

FIG. 3 depicts a different interference scenario in unlicensed spectrum. A base station of a wireless cellular communication network, eNB, operates in unlicensed spectrum, with the coverage area, or cell, depicted. Two UEs, UE₁ and UE₂, are shown within the cell, although of course in general there may be a large number of UEs. An Access Point AP₁ of a WLAN is depicted, along with its CCA range, or the geographic area over which it can effectively communicate with WLAN stations (STA). Two such stations, STA₁ and STA₂, are within the CCA range of AP₁. FIG. 3 also depicts the CCA range of WLAN stations STA₁ and STA₂. A third WLAN station STA₃ is depicted as located just outside the CCA range of AP₁. In this case, UE₁ is located within the CCA range of STA₂, and UL transmissions from STA₂ to AP₁ will cause interference at UE₁ with DL transmissions from the eNB.

FIG. 4 depicts a continuous function of the absolute value of a negative transmission format offset applied in the face of WLAN interference, which varies as a function of the interference power level. In this case, the LBT threshold for WLAN operation, such as IEEE 802.11x or Wi-Fi networks, is −62 dBm. This is referred to herein as the “characteristic interference power level” for WLAN interference. Note that each type of interference—that is, interference from a transmitter conforming to a particular wireless system protocol (e.g., eLAA, WLAN)—can have a different characteristic interference power level. In the embodiments discussed herein, the characteristic interference power level for an identified interference source is equal to the LBT threshold defined by that wireless protocol, although in general this is not necessary, and hence this is not a limitation of embodiments of the present invention. In this case, the eNB applies the highest transmission format offset at and around the WLAN characteristic interference power level of −62 dBm, since AP₁ and STA₃ will not defer transmissions in the face of interference up to that power level. To account for channel fading and the like, the eNB adds a margin of 10 dBm; and above −52 dBm, no offset is applied to the transmission format. The applied offset decreases for detected interference below the WLAN characteristic interference power level of −62 dBm.

According to embodiments described and claimed herein, the eNB estimates the source of interference detected in the channel, such as being from eLAA or WLAN. This estimate may be made, for example, by estimating OFDM symbol length by Cyclic Prefix (CP) correlation. Alternatively, the eNB may assume a received signal is generated by, e.g., a Wi-Fi transmitter, and attempt to decode a preamble of a Wi-Fi frame or packet, according to the relevant protocols. Other interference sources may be estimated as well. In general, the eNB calculates a transmission format offset in response to the interference power level and the source of interference. In some embodiments, as described above, a continuous function of offset vs. interference power level, as depicted in FIGS. 2 and 4, may be defined for each different source of interference. In other embodiments, a unique characteristic interference power level is defined for each source of interference, and a transmission format offset may be calculated based on the characteristic interference power level of the interference source.

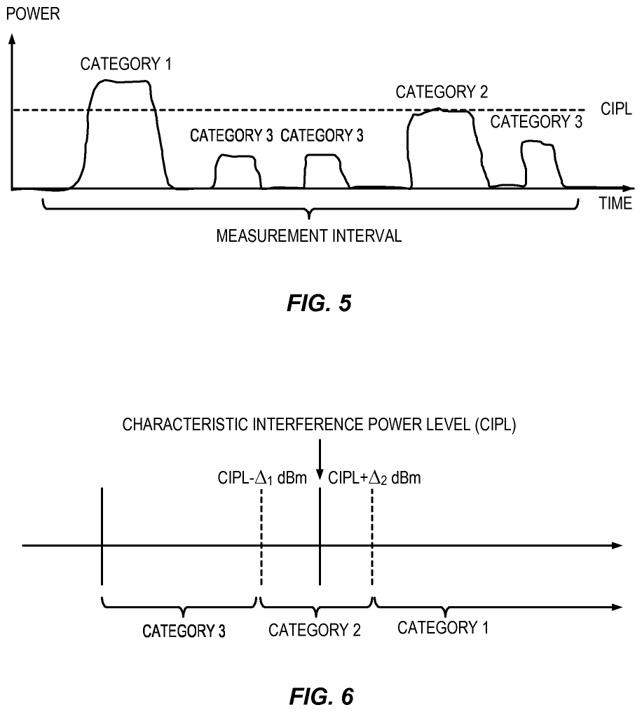

In some embodiments, the detected and measured interference is classified into categories based on a comparison of the measured interference power level to the characteristic interference power level for the estimated source of interference, and a transmission format offset is determined based on the classification. FIG. 5 depicts a representative plot of the power levels of interference signals detected over a measurement interval tₘ. A characteristic interference power level (CIPL) for the relevant source of interference is depicted in the graph. For example, if the source of interference is a WLAN transmitter, the CIPL=−62 dBm; if the source of interference is an eLAA eNB, the CIPL=−72 dBm. Other sources of interference may be assigned a characteristic interference power level unique to each source. The first interfering signal has a power level well above the characteristic interference power level. Although this interference is the strongest, it presents the least effect on eNB DL transmission integrity, since the interfering transmitter will defer transmission upon detecting interference at this power level, and hence will not cause additional interference to UE₁. Interfering signals well above this characteristic interference power level are accordingly classified into a first category, e.g., category 1. DL transmission from the eNB need not apply any transmission format offset for interference in category 1.

The fourth interfering signal has a power level right at the characteristic interference power level for the source of interference. As explained above, this signal presents the greatest challenge to DL transmission integrity from the eNB to UE₁, since at or below this level of interference, the interfering transmitter will not defer access for its own transmissions, which will cause interference at UE₁. Interfering signals close to this characteristic interference power level are accordingly classified into a second category, e.g., category 2.

FIG. 6 depicts that the definition of category 2 is a window around the characteristic interference power level for the particular interfering source. As well known in the art, a “window” defines a contiguous range, or extent, of power levels—in this case, the window extends above and below the characteristic interference power level. That is, in this case, the window CIPL −Δ₁<=rx_{pow}<=CIPL+Δ₂ defines category 2, where CIPL is the characteristic interference power level for the source of interference, rx_{pow} is the received interference power level and Δ₁ and Δ₂ are power level offsets. Note that Δ₁ and Δ₂ are not necessarily equal. Category 2 is defined as a window around the characteristic interference power level for robustness, accounting for channel fading and other real-world effects.

The second, third, and fifth interfering signals depicted in FIG. 5 present a medium impact on reception at UE₁. These signals are well below the level that would cause the interfering transmitter to defer transmissions as part of its own LBT protocol, and hence they may interfere with the DL transmission from the eNB to UE₁. Accordingly, the eNB is required to apply a more robust transmission format than what it may have calculated based on CQI and/or HARQ feedback from UE₁ alone. On the other hand, the transmission format probably need not be as robust as that required for category 2 interference. Accordingly, these interference powers are classified into a separate category, e.g., category 3. A transmission format offset is calculated separately for category 2 and category 3 interference.

In one embodiment, the transmission format offset is calculated after classifying the interference into the first, second, or third category according to:

$$offset = {\sum }_{x = 1}^{n} - {f}_{x} ( ) where {f}_{x} ( ) is a function for category x , x = \{ 1 , 2 , … , n \} ( here , n = 3 ) .$$

Note that the definition of only three categories in this example is representative only. In deployments where different sources or types of interference have different effects on DL transmission integrity, a larger number n of categories may be defined, with appropriate discrimination between them. Different functions for calculating an offset may then be defined for the different categories. Those of skill in the art may determine an appropriate number of interference categories n, and functions fₓ( ) defining an offset in response to classification into each category, for any given deployment, without undue experimentation, given the teachings of the present disclosure. One or more such offset calculation functions fₓ( ) may be zero, such as that for category 1 in the example of FIGS. 5 and 6.

In one embodiment, the functions to determine an offset for each category are defined as:

fₓ( )=wₓ*# interferersₓ where

wₓ is a weight for category x; and
# interferersₓ is the number of interfering transmissions in category x.

As one example, w₁=0, w₂=1, and w₃=0.5.

In another embodiment, the functions are defined as:

fₓ( )=wₓ*1/tₘ*sumᵢ(pow_{x,i}*len_{x,i}) where

wₓ is a weight for category x;
tₘ is a measurement time interval;
sumᵢ( ) is a summation over the i-th transmission;
pow_{x,i} is the power of the i-th transmission in the x-th interference category; and
len_{x,i} is the length of the i-th transmission in the x-th interference category.

In this embodiment, w₁=0, w₂>0, w₃>0, and w₃<w₂.

The offset determined by classification need not be constant for each category. In one embodiment, the functions fₓ( ) for each category are continuous functions (at least over each category), e.g., expressed mathematically or empirically as a function of an independent variable, such as interference power level. Examples of this embodiment are depicted in the graphs of FIGS. 2 and 4, where the absolute value of the offset for each category is a continuous function of the interference power level. For example, in the case of eLAA interference (FIG. 2), the eLAA characteristic interference power level is −72 dBm, Δ₁=Δ₂=10 dB, and the function defining the offset for category 2 (below this window) is zero. In the case of WLAN interference (FIG. 4), the WLAN characteristic interference power level is −62 dBm, and Δ₁=Δ₂=10 dB. In this case, interference between −82 and −72 dBm is classified into category 2. In this example, the functions defining the offsets are continuous across category boundaries, as well as throughout a category, although this is not necessarily required. Also, the offset within a category may be discontinuous, such as a step function, or the like.

However the offset is defined in response to detected interference in the channel and the source of interference, the initial transmission format is adjusted by the offset to yield a transmission format appropriate for transmission in the face of the interference. For example, the adjustment may comprise:

TF_{final}=TF_{base}+TF_{offset}, where

TF_{final} is the adjusted transmission format used to actually transmit data over the channel;
TF_{base} is the initial TF, calculated, for example, in response to CQI; and
TF_{offset} is an offset or adjustment applied to TF_{base} (note that TF_{offset} will typically be a negative value in the face of detected interference, to achieve a more robust DL transmission). The adjusted transmission format TF_{final} is then used to transmit the DL data.

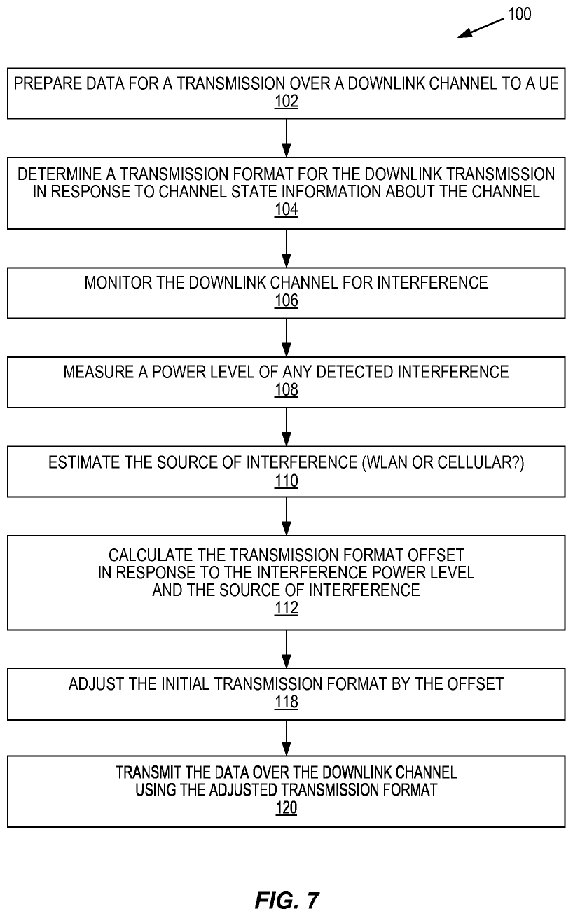

FIG. 7 depicts the steps of a method 100 of operating a base station of a wireless cellular communication system in unlicensed spectrum, e.g., the eNB depicted in FIG. 3. Data are prepared for a transmission over a DL channel to a UE (block 102). An initial transmission format TF_{base} for the DL transmission is determined, e.g., in response to CSI about the channel (block 104). The CSI may be reported to the eNB by the UE, and/or the eNB may obtain CSI from other sources. The eNB monitors the DL channel for interference, such as over a predetermined measurement interval tₘ (block 106). In one embodiment, monitoring the DL channel includes maintaining statistics of interference power levels and determined interference categories previously detected on the DL channel. Signals received on the DL channel are then compared to the statistics, to help determine whether they constitute interference. If interference is detected, its power level is measured (block 108). The eNB estimates the source of the interference, e.g., as being eLAA or WLAN, using the techniques discussed above (block 110).

A transmission format offset is calculated in response to the interference power level and the source of interference (block 112). In some embodiments, the transmission format offset is a continuous function, for each source of interference, of the interference power level. In other embodiments, a window is defined around a characteristic power level unique to the source of interference, and the interference is classified into categories around the window, according to the interference power level (e.g., above, within, and below the window). A different function for each category may then define the transmission format offset.

The initial transmission format TF_{base} is then adjusted by the offset TF_{offset} (block 118), and the data are transmitted on the downlink channel using the adjusted, or final, transmission format TF_{final}=TF_{base}+TF_{offset} (block 120).

Under an eLAA LBT protocol, prior to initiating a downlink transmission to a UE, if the eNB discovers interference in the downlink channel in excess of a LBT interference power level threshold (or LBT threshold) (e.g., −72 dBm), the eNB will defer access to the channel for its downlink transmission until another time. Preferably the deferral is relatively short—if appreciable time passes between the first attempt to transmit and the deferred transmission, channel conditions may have changed such that the initial transmission format (as possibly modified by an offset) is no longer valid.

In one embodiment, the eNB performs a spatial analysis, such as for example angle of arrival measurements, on one or both of the interfering signal and UL signals from a UE, to ascertain whether the source of interference is likely physically proximate to the UE. If so, the eNB increases the weights for category 2 or category 3 offset functions for that UE.

In one embodiment, the UE is also involved in the selection of TF_{offset} by the eNB, for DL transmissions. The UE performs periodic interference measurements, for example in response to commands from the eNB, and transmits interference reports to the eNB. The eNB receives the interference reports from one or more UEs and correlates them, in time and/or in frequency, with its own measurements of transmissions in the various interference categories. Interference from other devices in the unlicensed band will exhibit a typical on-off pattern due to the LBT, traffic load, the bursty nature of WLAN transmissions, etc. If the eNB and a UE measure a similar on-off pattern of interference, they are most likely subjected to the same interferers. The eNB will only consider UEs reporting a similar on-off pattern that have reported a higher (or at least equally high) interference level compared to the eNB's own interference measurements. The eNB will assign a larger weight to transmissions to UEs having high correlation and large power.

In one embodiment, the UE performs the correlations, and reports the results to the eNB. In this case, the eNB send an interference measurement report to the UE. The UE performs its own interference measurement, and correlates the two, in time and/or in frequency. The UE then reports the results of the correlations back to the eNB, which uses the results to adjust the weights for category 2 and category 3 offset generation functions for transmissions to the UE, based on the correlations.

Although embodiments disclosed herein focus on the eNB, they are also applicable to a UE that selects its own transmission format for UL transmissions. That is, in some embodiments the UE acquires CQI and/or HARQ feedback (e.g., from an eNB or otherwise), and calculates a TF_{base} for an UL transmission based on channel conditions. The UE monitors the channel for interference, adjusts TF_{base} by an offset determined in response to the interference power, and transmits its data to an eNB using the adjusted transmission format. In some embodiments, the UE also estimates the source of interference, and in the case of WLAN interference the offset is determined in response to classifying interference into categories based on interference power level.

In some embodiments, the UE receives interference reports from the eNB, and performs correlations in time and/or frequency to estimate whether the interference is from the same source. The UE then increases the absolute value of a TF_{offset} for UL transmissions to the eNB if the interference appears to be from the same source.

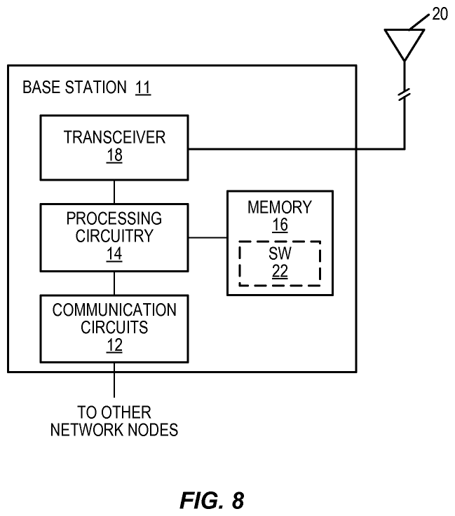

FIG. 8 depicts an eLAA base station 11, such as an eNB, operative in a wireless cellular communication network operating in unlicensed spectrum. The base station 11 includes communication circuits 12 operative to exchange data with other network nodes; processing circuitry 14; memory 16 storing software 22; and radio circuits, such as a transceiver 18, one or more antennas 20, and the like, to effect wireless communication across an air interface to one or more radio network devices, such as UE. As indicated by the broken connection to the antenna(s) 20, the antenna(s) may be physically located separately from the base station 11, such as mounted on a tower, building, or the like. Although the memory 16 is depicted as being separate from the processing circuitry 14, those of skill in the art understand that the processing circuitry 14 includes internal memory, such as a cache memory or register file. Those of skill in the art additionally understand that virtualization techniques allow some functions nominally executed by the processing circuitry 14 to actually be executed by other hardware, perhaps remotely located (e.g., in the so-called “cloud”).

According to one embodiment of the present invention, the processing circuitry 14 is operative to cause the base station 11 to adjust an initial transmission format in response to the power level of detected interference and the source of the interference, as described and claimed herein. In particular, the processing circuitry 14 is operative to perform the method 100 described and claimed herein. This allows the base station 11 to perform effective link adaptation in the face of interference unique to operation in unlicensed spectrum.

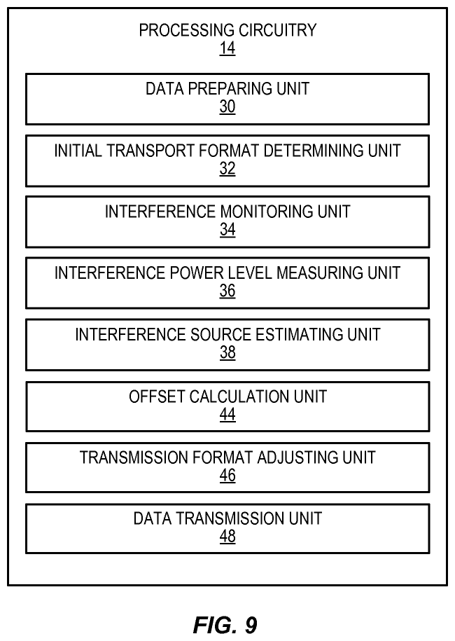

FIG. 9 illustrates example processing circuitry 14, such as that in the base station 11 of FIG. 8. The processing circuitry 14 comprises a plurality of physical units. In particular, the processing circuitry 14 comprises a data preparing unit 30, an initial transmission format determining unit 32, an interference monitoring unit 34, an interference power level measuring unit 36, an interference source estimating unit 38, an offset calculation unit 44, a transmission format adjusting unit 46, and a data transmitting unit 48.

The data preparing unit 30 is configured to prepare data for a transmission over a DL channel to a UE. The initial transmission format determining unit 32 is configured to determine an initial transmission format for the DL transmission in response to CSI about the channel. The interference monitoring unit 34 is configured to monitor the DL channel for interference. The interference power level measuring unit 36 is configured to measure a power level of any detected interference. The interference source estimating unit 38 is configured to estimate whether detected interference is generated by a eLAA or WLAN network. The offset calculation unit 44 is configured to calculate a transmission format offset in response to the interference power level and the source of interference. The transmission format adjusting unit 46 is configured to adjust the initial transmission format by the offset. The data transmitting unit 48 is configured to transmit the data over the DL channel using the adjusted transmission format.

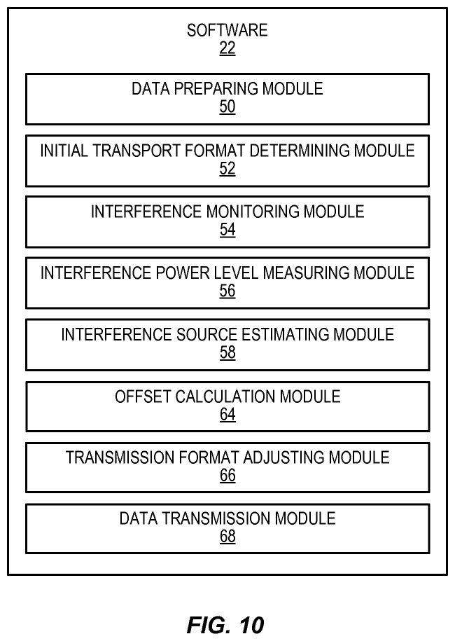

FIG. 10 illustrates example software 22, such as that in memory 16 in the base station 11 of FIG. 8. The software 22 comprises a plurality of software modules. In particular, the software 22 comprises a data preparing module 50, an initial transmission format determining module 52, an interference monitoring module 54, an interference power level measuring module 56, an interference source estimating module 58, a transmission format offset calculation module 64, a transmission format adjusting module 66, and a data transmitting module 68.

The data preparing module 50 is configured to prepare data for a transmission over a DL channel to a UE. The initial transmission format determining module 52 is configured to determine an initial transmission format for the DL transmission in response to CSI about the channel. The interference monitoring module 54 is configured to monitor the DL channel for interference. The interference power level measuring module 56 is configured to measure a power level of any detected interference. The interference source estimating module 58 is configured to estimate whether detected interference is generated by a eLAA or WLAN network. The offset calculation module 64 is configured to calculate a transmission format offset in response to the interference power level and the source of interference. The transmission format adjusting module 66 is configured to adjust the initial transmission format by the offset. The data transmitting module 68 is configured to transmit the data over the DL channel using the adjusted transmission format.

In all embodiments, the processing circuitry 14 may comprise any sequential state machine operative to execute machine instructions stored as machine-readable computer programs in memory 16, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), or any combination of the above.

In all embodiments, the memory 16 may comprise any non-transitory, machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like.

In all embodiments, the radio circuits may comprise one or more transceivers 18 used to communicate with one or more other transceivers via a Radio Access Network (RAN) according to one or more communication protocols known in the art or that may be developed, such as IEEE 802.xx, CDMA, WCDMA, GSM, LTE, eLAA, UTRAN, WiMax, NB-IoT, or the like. The transceiver 18 implements transmitter and receiver functionality appropriate to the RAN links (e.g., frequency allocations and the like). The transmitter and receiver functions may share circuit components and/or software, or alternatively may be implemented separately.

In all embodiments, the communication circuits 12 may comprise a receiver and transmitter interface used to communicate with one or more other nodes over a communication network according to one or more communication protocols known in the art or that may be developed, such as Ethernet, TCP/IP, SONET, ATM, IMS, SIP, or the like. The communication circuits 12 implement receiver and transmitter functionality appropriate to the communication network links (e.g., optical, electrical, and the like). The transmitter and receiver functions may share circuit components and/or software, or alternatively may be implemented separately.

Embodiments of the present invention present numerous advantages over the prior art. Prior art wireless cellular communication networks, particularly those based on or evolved from the 3GPP LTE protocols, lack functionality required to operate effectively in unlicensed spectrum. In particular, prior art link adaptation, e.g., based on CQI and/or HARQ feedback, generally fails to account for interference from other wireless system operation (e.g., eLAA, WLAN). Also, such feedback mechanisms are dependent on the transmitting node, e.g. the eNB receiving reports from a receiving node, e.g. a UE. According to embodiments disclosed and claimed herein, effective link adaptation comprises, the eNB calculating a transmission format offset in response to detected interference power levels and the source of interference, and adjusting a transmission format by the offset. Numerous specific implementations of such offset calculation are disclosed and discussed herein. Improved link adaptation in the face of interference sources allows wireless cellular communication networks to operate in unlicensed spectrum while maintaining a target BLER, and hence without incurring the retransmission load conventional link adaptation would incur.

The present disclosure may, of course, be carried out in other ways than those specifically set forth herein without departing from essential characteristics of the techniques. The present embodiments are to be considered in all respects as illustrative and not restrictive, and all changes coming within the meaning and equivalency range of the appended claims are intended to be embraced therein.

1-42. (canceled)

43. A method of operating a base station of a wireless cellular communication system in unlicensed spectrum, comprising:
preparing data for a transmission over a downlink channel to a User Equipment (UE);
determining an initial transmission format for the downlink transmission in response to channel state information about the channel;
monitoring the downlink channel for interference;
measuring a power level of any detected interference;
estimating the source of interference as a wireless cellular communication network transmission or a wireless local area network (WLAN) transmission;
calculating a transmission format offset in response to the interference power level and the source of interference;
adjusting the initial transmission format by the offset; and
transmitting the data over the downlink channel using the adjusted transmission format.

44. The method of claim 43 wherein monitoring the downlink channel for interference comprises:
maintaining statistics of interference power levels and determined interference categories previously detected on the downlink channel;
receiving signals from the downlink channel; and
determining if there is interference in the downlink channel at least in part by comparing characteristics of the received signals to the statistics.

45. The method of claim 43 wherein the transmission format comprises one or more of Modulation and Coding Scheme, MIMO rank, and precoder selection.

46. The method of claim 43 wherein estimating the source of interference comprises assuming a WLAN transmission and decoding a WLAN frame preamble.

47. The method of claim 43 wherein estimating the source of interference comprises correlating in time, with a delay between correlation taps, over an OFDM symbol length for one of LTE and IEEE 802.11.

48. The method of claim 43 wherein estimating the source of interference comprises receiving an estimate of the source of interference from the UE.

49. The method of claim 43 wherein the transmission format offset for each source of interference is a continuous function of the interference power level.

50. The method of claim 49 wherein each continuous function yields a maximum absolute value of offset at a characteristic interference power unique to the source of interference.

51. The method of claim 43 wherein calculating a transmission format offset in response to the interference power level and the source of interference comprises
defining a window of interference power levels around a characteristic interference power level unique to the source of interference;
classifying the interference into a first category comprising interference power levels above the window, a second category comprising interference power levels within the window, and a third category comprising interference power levels below the window; and
calculating the transmission format offset in response to classifying the interference into the first, second, or third category.

52. The method of claim 50 wherein the unique characteristic interference power for each source of interference is a Listen Before Talk (LBT) interference power level threshold defined by a protocol of the source of interference.

53. The method of claim 51 wherein calculating the transmission format offset in response to classifying the interference into the first, second, or third category comprises calculating the offset according to:
$$offset = {\sum }_{x = 1}^{n} - {f}_{x} ( ) where$$
fₓ( ) is a function for category x, x={1, 2, . . . , n}.

54. The method of claim 53 wherein f₃( )=0.

55. The method of claim 53 wherein
fₓ( )=wₓ*# interferersₓ, where wₓ is a weight for category x; and
# interferersₓ is the number of interfering transmissions in category x.

56. The method of claim 55 wherein w₁=0, w₃<w₂, w₂>0, and w₃>0.

57. The method of claim 53 wherein
fₓ( )=wₓ*1/tₘ*sumᵢ(pow_{x,i}*len_{x,i}), where
wₓ is a weight for category x;
tₘ is a measurement time interval;
sumᵢ( ) is a summation over the i-th transmission;
pow_{x,i} is the power level of the i-th transmission in the x-th interference category; and
len_{x,i} is the length of the i-th transmission in the x-th interference category.

58. The method of claim 57 wherein w₁=0, w₃<w₂, w₂>0, and w₃>0.

59. The method of claim 43 further comprising, after measuring a power level of any detected interference and prior to transmitting data over the downlink channel using an adjusted transmission format:
if the interference power level equals or exceeds a wireless cellular Listen Before Talk (LBT) interference power level threshold, deferring the downlink transmission.

60. The method of claim 43 further comprising, after measuring a power level of any detected interference and prior to transmitting data over the downlink channel using an adjusted transmission format:
receiving from the UE a report of interference measurements performed by the UE;
comparing the UE-measured interference to the base station measured interference; and
calculating the transmission format offset in response to the comparison.

61. The method of claim 60 wherein calculating the transmission format offset in response to the comparison comprises increasing the absolute value of the offset if the UE-measured interference and the base station measured interference exhibit a positive correlation in one or both of time and frequency.

62. The method of claim 60 wherein calculating the transmission format offset in response to the comparison comprises increasing the absolute value of the offset if the UE-measured interference and the base station measured interference exhibit a similar pattern of intermittent interference.

63. The method of claim 60 wherein calculating the transmission format offset in response to the comparison comprises:
performing spatial analysis on the interference and transmissions by the UE; and
increasing the absolute value of the offset if the spatial analysis indicates the source of interference is near the UE.

64. The method of claim 63 wherein the spatial analysis comprises performing angle-of-arrival measurements.

65. A base station of a wireless cellular communication system operative to operate in unlicensed spectrum, comprising:
one or more antennas;
a transceiver operatively connected to the antenna; and
processing circuitry operatively connected to the transceiver and operative to prepare data for a transmission over a downlink channel to a User Equipment (UE),
determine an initial transmission format for the downlink transmission in response to channel state information about the channel;
monitor the downlink channel for interference;
measure) a power level of any detected interference;
estimate the source of interference as a wireless cellular communication network transmission or a wireless local area network (WLAN) transmission; and
calculate a transmission format offset in response to the interference power level and the source of interference;
adjust the initial transmission format by the offset; and
transmit the data over the downlink channel using the adjusted transmission format.

66. The base station of claim 65 wherein the processing circuitry is operative to monitor the downlink channel for interference by:
maintaining statistics of interference power levels and determined interference categories previously detected on the downlink channel;
receiving signals from the downlink channel; and
determining if there is interference in the downlink channel at least in part by comparing characteristics of the received signals to the statistics.

67. The base station of claim 65 wherein the transmission format comprises one or more of Modulation and Coding Scheme, MIMO rank, and precoder selection.

68. The base station of claim 65 wherein the processing circuitry is operative to estimate the source of interference by assuming a WLAN transmission and decoding a WLAN frame preamble.

69. The base station of claim 65 wherein the processing circuitry is operative to estimate the source of interference by correlating in time, with a delay between correlation taps, over an OFDM symbol length for one of LTE and Wi-Fi.

70. The base station of claim 65 wherein the processing circuitry is operative to estimate the source of interference by receiving an estimate of the source of interference from the UE.

71. The base station of claim 65 wherein the transmission format offset for each source of interference is a continuous function of the interference power level.

72. The base station of claim 71 wherein each continuous function yields a maximum absolute value of offset at a characteristic interference power unique to the source of interference.

73. The base station of claim 65 wherein the processing circuitry is operative to calculate a transmission format offset in response to the interference power level and the source of interference by
defining a window of interference power levels around a characteristic interference power level unique to the source of interference;
classifying the interference into a first category comprising interference power levels above the window, a second category comprising interference power levels within the window, and a third category comprising interference power levels below the window; and
calculating the transmission format offset in response to classifying the interference into the first, second, or third category.

74. The base station of claim 73 wherein the unique characteristic interference power for each source of interference is a Listen Before Talk (LBT) interference power level threshold defined by a protocol of the source of interference.

75. The base station of claim 65 wherein the processing circuitry is operative to calculate an offset in response to classifying the interference into the first, second, or third category by calculating the offset according to:
$$offset = {\sum }_{x = 1}^{n} - {f}_{x} ( ) where$$
fₓ( ) is a function for category x, x={1, 2, . . . , n}.

76. The base station of claim 75 wherein f₃( )=0.

77. The base station of claim 75 wherein
fₓ( )=wₓ*# interferersₓ, where wₓ is a weight for category x; and
# interferersₓ is the number of interfering transmissions in category x.

78. The base station of claim 77 wherein w₁=0, w₃<w₂, w₂>0, and w₃>0.

79. The base station of claim 75 wherein
fₓ( )=wₓ*1/tₘ*sumᵢ(pow_{x,i}*len_{x,i}), where
wₓ is a weight for category x;
tₘ is a measurement time interval;
sumᵢ( ) is a summation over the i-th transmission;
pow_{x,i} is the power of the i-th transmission in the x-th interference category; and
len_{x,i} is the length of the i-th transmission in the x-th interference category.

80. The base station of claim 79 wherein w₁=0, w₃<w₂, w₂>0, and w₃>0.

81. The base station of claim 65 wherein the processing circuitry is further operative to, after measuring a power level of any detected and prior to transmitting data over the downlink channel using an adjusted transmission format:
if the interference power level equals or exceeds a Listen Before Talk (LBT) interference power level threshold, defer the downlink transmission.

82. The base station of claim 65 wherein the processing circuitry is further operative to, after measuring a power level of any detected interference and prior to transmitting data over the downlink channel using an adjusted transmission format:
receive from the UE a report of interference measurements performed by the UE;
compare the UE-measured interference to the base station measured interference; and
calculate the transmission format offset in response to the comparison.

83. The base station of claim 82 wherein the processing circuitry is operative to calculate the transmission format offset in response to the comparison by increasing the absolute value of the offset if the UE-measured interference and the base station measured interference exhibit a positive correlation in one or both of time and frequency.

84. The base station of claim 82 wherein the processing circuitry is operative to calculate the transmission format offset in response to the comparison by increasing the absolute value of the offset if the UE-measured interference and the base station measured interference exhibit a similar pattern of intermittent interference.

85. The base station of claim 82 wherein the processing circuitry is operative to calculate the transmission format offset in response to the comparison by:
performing spatial analysis on the interference and transmissions by the UE; and
increasing the absolute value of the offset if the spatial analysis indicates the source of interference is near the UE.

86. The base station of claim 82 wherein the processing circuitry is operative to perform spatial analysis by performing angle-of-arrival measurements.
